(19) United States
(12) Patent Application Publication
(10) Pub. No.: US 2010/0209840 A1
(43) Pub. Date: Aug. 19, 2010

(54) DEVELOPING AGENT AND METHOD FOR PRODUCING THE SAME

(75) Inventors: Masahiro Ikuta, Shizuoka-ken (JP); Takayasu Aoki, Shizuoka-ken (JP); Takashi Urabe, Shizuoka-ken (JP); Tsuyoshi Itou, Shizuoka-ken (JP); Satoshi Araki, Shizuoka-ken (JP); Motonari Udo, Shizuoka-ken (JP); Takafumi Hara, Shizuoka-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/638,145

(22) Filed: Dec. 15, 2009

Related U.S. Application Data
(60) Provisional application No. 61/140,006, filed on Dec. 22, 2008.

(51) Int. Cl. G03G 9/12; G03G 5/00

(52) U.S. Cl. 430/112; 430/137.22

(57) ABSTRACT

As a first dispersion liquid containing first fine particles and a second dispersion liquid containing second fine particles, those satisfy the relationship represented by the following formula (1) are used, and these two dispersion liquids are mixed with each other, and an aggregating agent and a pH adjusting agent are added thereto in sequence, whereby encapsulation is achieved by selective formation of core particles through aggregation of the first fine particles and shells through aggregation of the second fine particles.

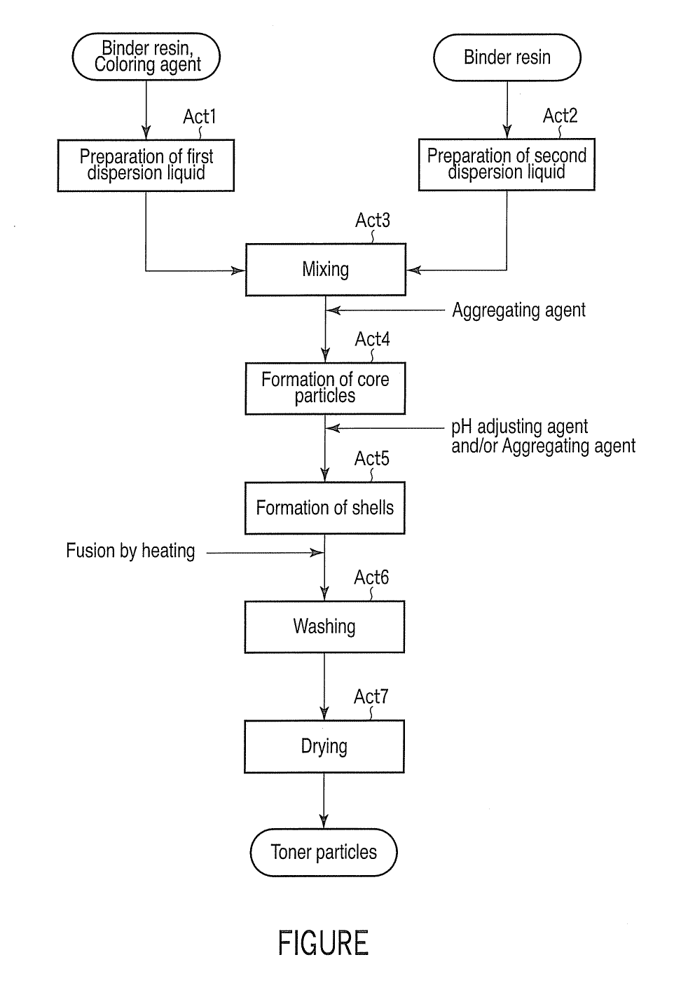

15 mV≧|Z2−Z1|≧5 mV (1)

In the formula, Z1 and Z2 represent zeta potentials of the first dispersion liquid and the second dispersion liquid, respectively, measured when aluminum sulfate is added to each dispersion liquid in an amount of 1% by weight based on the solid content in each dispersion liquid.

### CROSS-REFERENCE TO RELATED APPLICATIONS

This application is based upon and claims the benefit of priority from U.S. Provisional Application No. 61/140,006, filed Dec. 22, 2008, the entire contents of which are incorporated herein by reference.

### TECHNICAL FIELD

The present invention relates to a developing agent to be used for developing an electrostatic image or a magnetic latent image in electrophotography, electrostatic printing, magnetic recording, and the like; and a method for producing the same.

### BACKGROUND

In the past, as a method for producing a toner in which the shape and surface composition of toner particles are intentionally controlled, an aggregation method in which a dispersion liquid of fine particles containing at least a resin and a coloring agent is aggregated using, as an aggregating agent, a metal salt or a polymer aggregating agent, followed by fusion of components is proposed. For example, JP-A-63-282752 and JP-A-6-250439 disclose an aggregation method using a metal salt. JP-A-2003-316068 proposes an aggregation method using a polymer aggregating agent. In such an aggregation method, toner components in an inner portion and a surface portion of a toner are uniformly aggregated. Therefore, a release agent is present on the toner surface after fusion of the components, and an image which is stable for a long period of time cannot be formed due to occurrence of filming, deterioration of chargeability, or the like. Further, JP-A-10-73955 and JP-A-10-26842 propose a method for producing an electrophotographic toner having a core-shell structure including adding and mixing a separately prepared a dispersion liquid of shell particles with aggregated core particles obtained by the above-mentioned aggregation method thereby attaching the shell particles to the surfaces of the aggregated core particles. JP-A-2005-99081 proposes a method for producing an electrophotographic toner having a core-shell structure which is a three-layer structure with an intermediate layer containing a wax between a core layer and a shell layer.

However, the conventional methods for forming a core-shell structure have a problem that the procedure is complicated.

### SUMMARY

An object of the invention is to easily produce a developing agent having a core-shell structure.

A method for producing a developing agent of the invention includes:

forming a mixed dispersion liquid by mixing a first dispersion liquid containing first fine particles containing a first binder resin and a coloring agent with a second dispersion liquid containing second fine particles containing at least either one of the first binder resin and a second binder resin which is different from the first binder resin;

forming core particles by adding an aggregating agent to the mixed dispersion liquid to selectively aggregate the first fine particles; and

forming shells on the surfaces of the core particles by adding a pH adjusting agent to the mixed dispersion liquid containing the core particles to aggregate the second fine particles thereon; wherein

the absolute value of the difference between the zeta potential of the first dispersion liquid (Z1) and the zeta potential of the second dispersion liquid (Z2) measured when the concentration of solid content in each of the first dispersion liquid and the second dispersion liquid is set to 5% by weight, and aluminum sulfate is added to each dispersion liquid in an amount of 1% by weight based on the solid content satisfies the relationship represented by the following formula (1).

15 mV≧|Z2−Z1|≧5 mV (1)

Further, a developing agent of the invention contains:

core particles formed by using first fine particles containing a first binder resin and a coloring agent; and

shells formed on the surfaces of the core particles by using second fine particles containing at least either one of the first binder resin and a second binder resin which is different from the first binder resin; wherein

the developing agent is produced by mixing a first dispersion liquid containing the first fine particles with a second dispersion liquid containing the second fine particles to form a mixed dispersion liquid, and adding an aggregating agent to the mixed dispersion liquid to selectively aggregate the first fine particles thereby forming core particles, and then, adding an aggregating agent and a pH adjusting agent to the mixed dispersion liquid containing the core particles to aggregate the second fine particles on the surfaces of the core particles thereby forming shells; and

the absolute value of the difference between the zeta potential of the first dispersion liquid (Z1) and the zeta potential of the second dispersion liquid (Z2) measured when the concentration of solid content in each of the first dispersion liquid and the second dispersion liquid is set to 5% by weight, and aluminum sulfate is added to each dispersion liquid in an amount of 1% by weight based on the solid content satisfies the relationship represented by the following formula (1).

15 mV≧|Z2−Z1|≧5 mV (1)

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### DESCRIPTION OF THE DRAWING

The accompanying drawings, which are incorporated in and constitute a part of the specification, illustrate embodiments of the invention, and together with the general description given above and the detailed description of the embodiments given below, serve to explain the principles of the invention.

The single FIGURE is a flowchart for illustrating a method for producing a developing agent of the invention.

### DETAILED DESCRIPTION

Hereinafter, the method for producing a developing agent of the invention is described in more detail with reference to the drawing.

The FIGURE is a flowchart for illustrating the method for producing a developing agent of the invention.

In the method for producing a developing agent of the invention, basically, a first dispersion liquid containing first fine particles containing a first binder resin and a coloring agent and a second dispersion liquid containing second fine particles containing at least either one of the first binder resin and a second binder resin which is different from the first binder resin are used and the first fine particles are aggregated to form core particles, and then, the second fine particles are aggregated on the surfaces of the core particles to form shells, whereby a developing agent is produced.

The first dispersion liquid and the second dispersion liquid to be used in the invention are prepared such that the absolute value of the difference between the zeta potential of the first dispersion liquid (Z1) and the zeta potential of the second dispersion liquid (Z2) measured when aluminum sulfate is added to each dispersion liquid in an amount of 1% by weight based on the solid content in each dispersion liquid satisfies the relationship represented by the following formula (1).

15 mV≧|Z2−Z1|≧5 mV (1)

In the invention, as shown in the drawing, first, a first dispersion liquid and a second dispersion liquid which satisfy the relationship represented by the above formula (1) are prepared, respectively (Act 1, Act 2).

Subsequently, the first dispersion liquid and the second dispersion liquid are mixed with each other to prepare a mixed dispersion liquid (Act 3). Then, by adding an aggregating agent thereto, first fine particles are selectively aggregated to form core particles (Act 4).

Thereafter, by adding an aggregating agent and a pH adjusting agent thereto, second fine particles are selectively aggregated on the surfaces of the core particles to form shells (Act 5), whereby particles having a core-shell structure are obtained.

Further, the particles having a core-shell structure are optionally fused by heating, and then, washed (Act 6) and dried (Act 7), whereby toner particles are obtained.

Further, the developing agent of the invention is a developing agent obtained by the above method, and contains core particles formed by using first fine particles containing a first binder resin and a coloring agent and substantially composed of the first fine particles; and shells formed on the surfaces of the core particles by using second fine particles containing at least either one of the first binder resin and a second binder resin which is different from the first binder resin and substantially composed of the second fine particles.

According to the invention, the first dispersion liquid and the second dispersion liquid are mixed with each other and, to the resulting mixed dispersion liquid, an aggregating agent and a pH adjusting agent are added in sequence, whereby core particles and shells can be sequentially formed in one mixed dispersion liquid, and thus, a developing agent having a core-shell structure can be easily obtained.

In order to aggregate the fine particles in the dispersion liquid, by adding an aggregating agent such as a metal salt, the zeta potential of the fine particles is brought close to 0 to decrease the dispersion stability. The dispersion stability of the fine particles depends on the dispersibility of the fine particles per se and a dispersant such as a surfactant. As the addition amount of the surfactant is increased, the absolute value of the zeta potential increases and the dispersion stability of the fine particles increases. For example, by mixing two types of dispersion liquids containing different surfactant materials, a difference in decrease in the zeta potential due to the addition of an aggregating agent can be generated. In this manner, only the first fine particles can be selectively aggregated by controlling aggregation.

In the invention, a developing agent having a core-shell structure which is so-called a capsule toner is produced by mixing fine particle dispersion liquids before adding an aggregating agent and selectively aggregating only particles which become a core with the use of the difference in aggregability between particles which become a core and particles which become a shell through controlling of the dispersion stability of these particles. By forming a core-shell structure, the composition of the toner surface becomes uniform and the release agent is suppressed from being exposed on the surface, and therefore, occurrence of filming, deterioration of chargeability or the like is prevented, and thus, an image which is stable over a long period of time can be formed.

In the invention, toner particles having a core-shell structure are produced by controlling the difference in dispersion stability of the particles which become a core and the particles which become a shell. Toner material particles, i.e., the particles which become a core and the particles which become a shell can be applied to a method for effecting production in an aqueous medium such as an aggregation method or a suspension polymerization method. Also, toner material particles produced by a pulverization method can be dispersed in an aqueous medium. In the aggregation method, prior to aggregation, a dispersion liquid of fine particles which become a core is mixed with a dispersion liquid of resin fine particles which become a shell having higher dispersion stability than the dispersion liquid of fine particles which become a core, and aggregation of the fine particles in the dispersion liquid of fine particles which become a core is allowed to proceed by effecting aggregation to form aggregated particles having a size of 2 to 10 μm, and the particles in the dispersion liquid of resin fine particles which become a shell are intentionally not aggregated and left unaggregated. Thereafter, the difference in dispersion stability between the dispersion liquid of fine particles which become a core and the dispersion liquid of resin fine particles which become a shell is decreased by adjusting the pH, adding an aggregating agent or the like to form toner particles having a core-shell structure.

As for the method of controlling the dispersion stability, the dispersion stability can be controlled by employing the difference in the addition amount of a surfactant when the fine particle dispersion liquid is prepared. Further, in the evaluation of the dispersion stability, a zeta potential is used. The absolute value of the difference between the zeta potential of the first dispersion liquid (Z1) and the zeta potential of the second dispersion liquid (Z2) measured when the concentration of solid content in each of the first and second dispersion liquids is set to 5% by weight, and aluminum sulfate is added to each dispersion liquid in an amount of 1% by weight based on the solid content satisfies the relationship represented by the following formula (1).

15 mV≧|Z2−Z1|≧5 mV (1)

When the difference in zeta potential is less than mV, particles which become a shell are incorporated in core particles during aggregation of particles which become a core, and therefore, a core-shell structure cannot be formed.

When the difference in zeta potential exceeds mV, the zeta potential of particles which become a core cannot be sufficiently decreased, and therefore, a problem arises that unaggregated particles which cannot form a capsule shell remain.

The solid content weight ratio of the second dispersion liquid to the first dispersion liquid is preferably 4/6≧(second dispersion liquid)/(first dispersion liquid)≧1/9. If the solid content weight ratio of the second dispersion liquid to the first dispersion liquid is less than 1/9, the surfaces of core particles are not sufficiently covered, and the composition of the surfaces of toner particles tends to be ununiform. If the solid content weight ratio of the second dispersion liquid to the first dispersion liquid is more than 4/6, homoaggregation of particles which become a shell occurs and the coating layer on the surfaces of core particles becomes too thick, and therefore, an effect of the release agent is not exhibited and a non-offset temperature range tends to be insufficient.

Further, by mixing three or more types of fine particle dispersion liquids, an electrophotographic toner having a multilayer structure of three or more layers can be produced.

The volume average particle diameter of the fine particles which become a core can be set to 2 to 10 μm. Further, the volume average particle diameter of the fine particles which become a second layer serving as a shell can be set to 0.3 to 1.0 μm.

The first fine particles can be prepared by, for example, a method in which toner particle material containing a binder resin and a coloring agent is melt-kneaded, the resulting kneaded material is pulverized to obtain a coarsely pulverized material, and the coarsely pulverized material is subjected to a mechanical sharing device to form fine particles or a polymerization method, or the like.

To the first fine particles, a release agent can be added.

By adding a release agent to the first fine particles and forming shells using the second fine particles, the release agent is hardly exposed on the surfaces of the toner particles.

The second fine particles are composed of a binder resin in whole or at least in part.

The binder resins to be used in the first fine particles and the second fine particles may be of the same resin material or of different resin materials.

With respect to the grass transition temperature (Tg) of the resins in the fine particle dispersion liquids, from the viewpoint of storage stability of a toner, the glass transition temperature (Tg) of the second binder resin to be used in the second dispersion liquid is preferably higher than that of the first binder resin to be used in the first dispersion liquid.

### Zeta Potential Measurement Method

A fine particle dispersion liquid is diluted with ion exchanged water such that the concentration of the solid content is 5% by weight, and 5% by weight of aluminum sulfate is added thereto in an amount of 1% by weight based on the solid content in the fine particle dispersion liquid. The resulting dispersion liquid is diluted to 5 ppm, and a zeta potential thereof is measured. The zeta potential is measured using a zeta potential analyzer ZEECOM (manufactured by Microtech Nition Co., Ltd.). The cell position is set to 15 mm, and the voltage is set to 70 V, and 50 particles are randomly selected and measured. The average measurement value is determined to be a zeta potential.

As materials to be used in the invention, any materials known as toner materials such as a resin, a coloring agent, and a release agent can be used.

Examples of the binder resin to be used in the invention include styrene resins such as polystyrene, styrene/butadiene copolymers, and styrene/acrylic copolymers; ethylene resins such as polyethylene, polyethylene/vinyl acetate copolymers, polyethylene/norbornene copolymers, and polyethylene/vinyl alcohol copolymers; polyester resins, acrylic resins, phenol resins, epoxy resins, allyl phthalate resins, polyamide resins, and maleic resins. These resins may be used alone or in combination of two or more of them.

The binder resin preferably has an acid value of 1 or more.

Examples of the coloring agent to be used in the invention include carbon blacks, and organic or inorganic pigments or dyes. Examples of the carbon black include acetylene black, furnace black, thermal black, channel black, and Ketjen black. Further, examples of a yellow pigment include C.I. Pigment Yellow 1, 2, 3, 4, 5, 6, 7, 10, 11, 12, 13, 14, 15, 16, 17, 23, 65, 73, 74, 81, 83, 93, 95, 97, 98, 109, 117, 120, 137, 138, 139, 147, 151, 154, 167, 173, 180, 181, 183, and 185, and C.I. Vat Yellow 1, 3, and 20. These can be used alone or in admixture. Examples of a magenta pigment include C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48, 49, 50, 51, 52, 53, 54, 55, 57, 58, 60, 63, 64, 68, 81, 83, 87, 88, 89, 90, 112, 114, 122, 123, 146, 150, 163, 184, 185, 202, 206, 207, 209, and 235, C.I. Pigment Violet 19, and C.I. Vat Red 1, 2, 10, 13, 15, 23, 29, and 35. These can be used alone or in admixture. Examples of a cyan pigment include C.I. Pigment Blue 3, 15, 16, and 17, C.I. Vat Blue 6, and C.I. Acid Blue 45. These can be used alone or in admixture.

Examples of the release agent to be used in the invention include aliphatic hydrocarbon waxes such as low molecular weight polyethylene, low molecular weight polypropylene, polyolefin copolymers, polyolefin waxes, microcrystalline waxes, paraffin waxes, and Fischer-Tropsch waxes; oxides of an aliphatic hydrocarbon wax such as polyethylene oxide waxes or block copolymers thereof; vegetable waxes such as candelilla wax, carnauba wax, Japan wax, jojoba wax, and rice wax; animal waxes such as bees wax, lanolin, and whale wax; mineral waxes such as ozokerite, ceresin, and petrolatum; waxes containing, as the major component, a fatty acid ester such as montanic acid ester wax and castor wax; and deoxidation products resulting from deoxidization of a part or the whole of a fatty acid ester such as deoxidized carnauba wax. Further, saturated linear fatty acids such as palmitic acid, stearic acid, montanic acid, and long-chain alkyl carboxylic acids having a long-chain alkyl group; unsaturated fatty acids such as brassidic acid, eleostearic acid, and parinaric acid; saturated alcohols such as stearyl alcohol, eicosyl alcohol, behenyl alcohol, carnaubyl alcohol, ceryl alcohol, melissyl alcohol, and long-chain alkyl alcohols having a long-chain alkyl group; polyhydric alcohols such as sorbitol; fatty acid amides such as linoleic acid amide, oleic acid amide, and lauric acid amide; saturated fatty acid bisamides such as methylenebis stearic acid amide, ethylenebis caprylic acid amide, ethylenebis lauric acid amide, and hexamethylenebis stearic acid amide; unsaturated fatty acid amides such as ethylenebis oleic acid amide, hexamethylenebis oleic acid amide, N,N′-dioleyl adipic acid amide, and N,N′-dioleyl sebaccic acid amide; aromatic bisamides such as m-xylenebis stearic acid amide and N,N′-distearyl isophthalic acid amide; fatty acid metal salts (generally called metallic soaps) such as calcium stearate, calcium laurate, zinc stearate, and magnesium stearate; waxes obtained by grafting a vinyl monomer such as styrene or acrylic acid onto an aliphatic hydrocarbon wax; partially esterified products of a fatty acid and a polyhydric alcohol such as behenic acid monoglyceride; and methyl ester compounds having a hydroxyl group obtained by hydrogenation of a vegetable fat or oil can be exemplified.

As the charge control agent for controlling a frictional charge quantity which can be used in the invention, for example, a positively charged charge control agent such as a nigrosine dye, a quaternary ammonium compound, or a polyamine resin, or a metal-containing azo compound is used. Further, a complex or a complex salt in which the metal element is iron, cobalt, or chromium, or a mixture thereof, or a metal-containing salicylic acid derivative compound can also be used, and a negatively charged charge control agent such as a complex or a complex salt in which the metal element is zirconium, zinc, chromium, or boron, or a mixture thereof can be used.

Examples of the surfactant which can be used in the invention include anionic surfactants such as sulfate-based, sulfonate-based, phosphate-based, and soap-based anionic surfactants; cationic surfactants such as amine salt-type, and quaternary ammonium salt-type cationic surfactants; and nonionic surfactants such as polyethylene glycol-based, alkyl phenol ethylene oxide adduct-based, and polyhydric alcohol-based nonionic surfactants. These surfactants may be used alone or in combination of two or more of them.

Examples of the aggregating agent which can be used in the aggregation step of the invention include metal salts such as sodium chloride, calcium chloride, calcium nitrate, barium chloride, magnesium chloride, zinc chloride, sodium sulfate, magnesium sulfate, aluminum chloride, aluminum sulfate, and potassium aluminum sulfate; inorganic metal salt polymers such as poly(aluminum chloride), poly(aluminum hydroxide), and calcium polysulfide; nonmetal salts such as ammonium chloride and ammonium sulfate; alcohols such as methanol, ethanol, 1-propanol, 2-propanol, 2-methyl-2-propanol, 2-methoxyethanol, 2-ethoxyethanol, and 2-butoxyethanol; organic solvents such as acetonitrile and 1,4-dioxane; inorganic acids such as hydrochloric acid and nitric acid; and organic acids such as formic acid and acetic acid.

An inversion agent which can be used in the invention can be selected from the above-mentioned surfactants and aggregating agents.

As a neutralizing agent which can be used in the invention, an inorganic base or an amine compound can be used. Examples of the inorganic base include sodium hydroxide and potassium hydroxide. Examples of the amine compound include dimethylamine, trimethylamine, monoethylamine, diethylamine, triethylamine, propylamine, isopropylamine, dipropylamine, butylamine, isobutylamine, sec-butylamine, monoethanolamine, diethanolamine, triethanolamine, triisopropanolamine, isopropanolamine, dimethylethanolamine, diethylethanolamine, N-butyldiethanolamine, N,N-dimethyl-1,3-diaminopropane, and N,N-diethyl-1,3-diaminopropane.

As the method for preparing a dispersion liquid of fine particles containing at least a binder resin and a coloring agent and optionally containing a release agent, use of a mechanical shearing device, a phase inversion emulsification method, and the like can be exemplified.

As the mechanical shearing device to be used in the invention, any known device can be used. Examples thereof include medium-free stirrers such as ULTRA TURRAX (manufactured by IKA Japan K.K.), T.K. AUTO HOMO MIXER (manufactured by PRIMIX Corporation), T.K. PIPELINE HOMO MIXER (manufactured by PRIMIX Corporation), T.K. FILMICS (manufactured by PRIMIX Corporation), CLEAR MIX (manufactured by M TECHNIQUE Co., Ltd.), CLEAR SS5 (manufactured by M TECHNIQUE Co., Ltd.), CAVITRON (manufactured by EUROTEC, Ltd.), and FINE FLOW MILL (manufactured by Pacific Machinery & Engineering Co., Ltd.); medium stirrers such as VISCO MILL (manufactured by Aimex Co., Ltd.), APEX MILL (manufactured by Kotobuki Industries Co., Ltd.), STAR MILL (manufactured by Ashizawa Finetech Co., Ltd.), DCP SUPER FLOW (manufactured by Nippon Eirich Co., Ltd.), MP MILL (manufactured by Inoue Manufacturing Co., Ltd.), SPIKE MILL (manufactured by Inoue Manufacturing Co., Ltd.), MIGHTY MILL (manufactured by Inoue Manufacturing Co., Ltd.), and SC MILL (manufactured by Mitsui Mining Co., Ltd.); and high-pressure impact-type dispersing devices such as Ultimizer (manufactured by Sugino Machine Limited), Nanomizer (manufactured by Yoshida Kikai Co. Ltd.), and NANO 3000 (manufactured by Beryu Co., Ltd.).

### EXAMPLES

Hereinafter, the invention is described in more detail with reference to Examples.

Physical properties related to a toner were determined by the following methods.

### Method of Measuring Finely Pulverized Particle Diameter

The finely pulverized particle diameter is measured using SALD-7000 (manufactured by Shimadzu Corporation).

### Method of Measuring Toner Particle Diameter

The toner particle diameter is measured using Multisizer 3 (aperture diameter: 100 μm, manufactured by Beckman Coulter Inc.).

### Preparation of Fine Particle Dispersion Liquid A

90 parts by weight of a polyester resin (Tg: 50° C.) as a binder resin, 5 parts by weight of a copper phthalocyanine pigment as a coloring agent, and 5 parts by weight of an ester wax as a release agent were mixed, and the resulting mixture was melt-kneaded using a twin screw kneader which was set to a temperature of 120° C., whereby a kneaded material was obtained.

The thus obtained kneaded material was coarsely pulverized to a volume average particle diameter of 1.2 mm using a hammer mill manufactured by Nara Machinery Co., Ltd., whereby coarse particles were obtained.

The thus obtained coarse particles were moderately pulverized to a volume average particle diameter of 0.05 mm using a bantam mill manufactured by Hosokawa Micron Corporation, whereby moderately pulverized particles were obtained.

40 parts by weight of the thus obtained moderately pulverized particles, 0.4 parts by weight of sodium dodecylbenzene sulfonate as an anionic surfactant, 1 part by weight of triethylamine as an amine compound, and 58.6 parts by weight of ion exchanged water were processed at 160 MPa and 180° C. using NANO 3000, whereby a dispersion liquid (1) of fine particles having a volume average particle diameter of 400 nm was prepared.

The zeta potential of this dispersion liquid was measured by the above-mentioned zeta potential measurement method and found to be −27.64 mV.

### Preparation of Fine Particle Dispersion Liquid B

90 parts by weight of a polyester resin (Tg: 55° C.) as a binder resin, 5 parts by weight of a copper phthalocyanine pigment as a coloring agent, and 5 parts by weight of an ester wax as a release agent were mixed, and the resulting mixture was melt-kneaded using a twin screw kneader which was set to a temperature of 120° C., whereby a kneaded material was obtained.

The thus obtained kneaded material was coarsely pulverized to a volume average particle diameter of 1.2 mm using a hammer mill manufactured by Nara Machinery Co., Ltd., whereby coarse particles were obtained.

The thus obtained coarse particles were moderately pulverized to a volume average particle diameter of 0.05 mm using a bantam mill manufactured by Hosokawa Micron Corporation, whereby moderately pulverized particles were obtained.

40 parts by weight of the thus obtained moderately pulverized particles, 0.4 parts by weight of sodium dodecylbenzene sulfonate as an anionic surfactant, 1 part by weight of triethylamine as an amine compound, and 58.6 parts by weight of ion exchanged water were processed at 160 MPa and 180° C. using NANO 3000, whereby a dispersion liquid (1) of fine particles having a volume average particle diameter of 500 nm was prepared.

The zeta potential of this dispersion liquid was measured by the above-mentioned zeta potential measurement method and found to be −29.27 mV.

### Preparation of Fine Particle Dispersion Liquid C

90 parts by weight of a polyester resin (Tg: 60° C.) as a binder resin, 5 parts by weight of a copper phthalocyanine pigment as a coloring agent, and 5 parts by weight of an ester wax as a release agent were mixed, and the resulting mixture was melt-kneaded using a twin screw kneader which was set to a temperature of 120° C., whereby a kneaded material was obtained.

The thus obtained kneaded material was coarsely pulverized to a volume average particle diameter of 1.2 mm using a hammer mill manufactured by Nara Machinery Co., Ltd., whereby coarse particles were obtained.

The thus obtained coarse particles were moderately pulverized to a volume average particle diameter of 0.05 mm using a bantam mill manufactured by Hosokawa Micron Corporation, whereby moderately pulverized particles were obtained.

40 parts by weight of the thus obtained moderately pulverized particles, 0.4 parts by weight of sodium dodecylbenzene sulfonate as an anionic surfactant, 1 part by weight of triethylamine as an amine compound, and 58.6 parts by weight of ion exchanged water were processed at 160 MPa and 180° C. using NANO 3000, whereby a dispersion liquid (1) of fine particles having a volume average particle diameter of 450 nm was prepared.

The zeta potential of this dispersion liquid was measured by the above-mentioned zeta potential measurement method and found to be −29.31 mV.

### Preparation of Fine Particle Dispersion Liquid D

A polyester resin (Tg: 60° C.) as a binder resin was moderately pulverized to a volume average particle diameter of 0.05 mm using a bantam mill manufactured by Hosokawa Micron Corporation, whereby moderately pulverized particles were obtained. 20 parts by weight of the thus obtained moderately pulverized particles, 2 parts by weight of sodium dodecylbenzene sulfonate as an anionic surfactant, 0.5 parts by weight of triethylamine as an amine compound, and 77.5 parts by weight of ion exchanged water were processed at 160 MPa and 180° C. using NANO 3000, whereby a dispersion liquid (2) of fine particles having a volume average particle diameter of 100 nm was prepared.

The zeta potential of this dispersion liquid was measured by the above-mentioned zeta potential measurement method and found to be −35.87 mV.

### Preparation of Fine Particle Dispersion Liquid E

A polyester resin (Tg: 50° C.) as a binder resin was moderately pulverized to a volume average particle diameter of 0.05 mm using a bantam mill manufactured by Hosokawa Micron Corporation, whereby moderately pulverized particles were obtained. 20 parts by weight of the thus obtained moderately pulverized particles, 2 parts by weight of sodium dodecylbenzene sulfonate as an anionic surfactant, 0.5 parts by weight of triethylamine as an amine compound, and 77.5 parts by weight of ion exchanged water were processed at 160 MPa and 180° C. using NANO 3000, whereby a dispersion liquid (2) of fine particles having a volume average particle diameter of 110 nm was prepared.

The zeta potential of this dispersion liquid was measured by the above-mentioned zeta potential measurement method and found to be −36.17 mV.

### Preparation of Fine Particle Dispersion Liquid F

Preparation was performed in the same manner as the fine particle dispersion liquid D except that the amount of the anionic surfactant (sodium dodecylbenzene sulfonate) was changed from 2 parts by weight to 0.6 parts by weight, whereby a dispersion liquid (2) of fine particles having a volume average particle diameter of 180 nm was prepared.

The zeta potential of this dispersion liquid was measured by the above-mentioned zeta potential measurement method and found to be −32.96 mV.

### Preparation of Fine Particle Dispersion Liquid G

Preparation was performed in the same manner as the fine particle dispersion liquid D except that the amount of the anionic surfactant (sodium dodecylbenzene sulfonate) was changed from 2 parts by weight to 0.3 parts by weight, whereby a dispersion liquid (2) of fine particles having a volume average particle diameter of 200 nm was prepared.

The zeta potential of this dispersion liquid was measured by the above-mentioned zeta potential measurement method and found to be −30.82 mV.

### Preparation of Fine Particle Dispersion Liquid H

Preparation was performed in the same manner as the fine particle dispersion liquid D except that the amount of the anionic surfactant (sodium dodecylbenzene sulfonate) was changed from 2 parts by weight to 2.5 parts by weight, whereby a dispersion liquid (2) of fine particles having a volume average particle diameter of 100 nm was prepared.

The zeta potential of this dispersion liquid was measured by the above-mentioned zeta potential measurement method and found to be −42.32 mV.

### Preparation of Fine Particle Dispersion Liquid I

Preparation was performed in the same manner as the fine particle dispersion liquid D except that the amount of the anionic surfactant (sodium dodecylbenzene sulfonate) was changed from 2 parts by weight to 2.8 parts by weight, whereby a dispersion liquid (2) of fine particles having a volume average particle diameter of 100 nm was prepared.

The zeta potential of this dispersion liquid was measured by the above-mentioned zeta potential measurement method and found to be −43.16 mV.

### Example 1

20 parts by weight of the fine particle dispersion liquid A, 10 parts by weight of the fine particle dispersion liquid D, and 45 parts by weight of ion exchanged water were mixed. Then, as an aggregating agent, 5 parts by weight of a 0.8% by weight aqueous HCl solution was added thereto at 30° C., and the temperature of the resulting mixture was raised to 50° C. Thereafter, 20 parts by weight of a 15% by weight aqueous ammonium chloride solution was added thereto to form a shell layer. In order to control the shape, the temperature of the resulting mixture was raised to 90° C. and the mixture was left as such for 2 hours.

After the obtained dispersion liquid was cooled, the solid matter therein was washed by repeating a procedure including centrifugation of the dispersion liquid using a centrifuge, removal of the resulting supernatant, and washing of the remaining solid matter with ion exchanged water until the electrical conductivity of the supernatant became 50 μS/cm. Thereafter, the resulting solid matter was dried using a vacuum dryer until the water content therein became 0.3% by weight, whereby toner particles were obtained.

After drying, as additives, 2 parts by weight of hydrophobic silica and 0.5 parts by weight of titanium oxide were attached to the surfaces of the toner particles, whereby a desired electrophotographic toner was obtained.

The volume average particle diameter of the thus obtained electrophotographic toner was measured using Multisizer 3 manufactured by Beckman Coulter Inc. and found to be 5.81 μm.

The thus obtained toner was evaluated as follows.

### Filming

100 k sheets (100,000 sheets) of paper were fed through a copier e-STUDIO 4520C manufactured by Toshiba Tec Corporation at 6% coverage. Then, solid images (A3 size) were output, and the width of the range where filming occurred on the photoconductive drum was examined.

The case where no filming was observed was evaluated as “A”, the case where the width was 5 mm or less was evaluated as “B”, and the case where the width was 5 mm or more was evaluated as “C”.

### Charge Amount

The charge amounts under high temperature and high humidity conditions (HH) and low temperature and low humidity conditions (LL) were measured using a charge measurement system for powder (TYPE TB-203) manufactured by KYOCERA Chemical Corporation.

The case where HH/LL was 70% or more was evaluated as “A”, the case where HH/LL was from 50 to 70% was evaluated as “B”, and the case where the HH/LL was 50% or less was evaluated as “C”.

### Non-Offset Temperature Range

A copier e-STUDIO 4520C manufactured by Toshiba Tec Corporation was modified, and the non-offset temperature range was examined by intentionally changing the fixing temperature.

The case where the non-offset temperature range was 40° C. or more was evaluated as “A”, the case where the non-offset temperature range was from 10 to 40° C. was evaluated as “B”, and the case where the non-offset temperature range was 10° C. or less was evaluated as

### Storage Stability

The storage stability was examined by leaving 20 g of a toner at 50° C. for 8 hours and measuring the amount of the toner remaining on a 42-mesh sieve after vibrating the sieve at 50 Hz for 10 seconds using POWDER TESTER (manufactured by Hosokawa Micron Corporation).

The case where the toner amount was less than 1 g was evaluated as “A”, the case where the toner amount was from 1 to 4 g was evaluated as “B”, and the case where the toner amount was 4 g or more was evaluated as “C”.

Good results were obtained with respect to all the test items: filming, charge amount, non-offset temperature range, and storage stability.

The results are shown in the following Table 1.

### Example 2

15 parts by weight of the fine particle dispersion liquid A, 20 parts by weight of the fine particle dispersion liquid D, and 40 parts by weight of ion exchanged water were mixed. Then, as an aggregating agent, 5 parts by weight of a 0.8% by weight aqueous HCl solution was added thereto at 30° C., and the temperature of the resulting mixture was raised to 50° C. Thereafter, 20 parts by weight of a 15% by weight aqueous ammonium chloride solution was added thereto to form a shell layer. In order to control the shape, the temperature of the resulting mixture was raised to 90° C. and the mixture was left as such for 2 hours.

After the obtained dispersion liquid was cooled, the solid matter therein was washed by repeating a procedure including centrifugation of the dispersion liquid using a centrifuge, removal of the resulting supernatant, and washing of the remaining solid matter with ion exchanged water until the electrical conductivity of the supernatant became 50 μS/cm. Thereafter, the resulting solid matter was dried using a vacuum dryer until the water content therein became 0.3% by weight, whereby toner particles were obtained.

After drying, as additives, 2 parts by weight of hydrophobic silica and 0.5 parts by weight of titanium oxide were attached to the surfaces of the toner particles, whereby a desired electrophotographic toner was obtained.

The volume average particle diameter of the thus obtained electrophotographic toner was measured using Multisizer 3 manufactured by Beckman Coulter Inc. and found to be 6.32 μm.

The thus obtained toner was evaluated and good results were obtained with respect to all the test items: filming, charge amount, non-offset temperature range, and storage stability.

The results are shown in the following Table 1.

### Example 3

22.5 parts by weight of the fine particle dispersion liquid A, 5 parts by weight of the fine particle dispersion liquid D, and 47.5 parts by weight of ion exchanged water were mixed. Then, as an aggregating agent, 5 parts by weight of a 0.8% by weight aqueous HCl solution was added thereto at 30° C., and the temperature of the resulting mixture was raised to 50° C. Thereafter, 20 parts by weight of a 15% by weight aqueous ammonium chloride solution was added thereto to form a shell layer. In order to control the shape, the temperature of the resulting mixture was raised to 90° C. and the mixture was left as such for 2 hours.

After the obtained dispersion liquid was cooled, the solid matter therein was washed by repeating a procedure including centrifugation of the dispersion liquid using a centrifuge, removal of the resulting supernatant, and washing of the remaining solid matter with ion exchanged water until the electrical conductivity of the supernatant became 50 μS/cm. Thereafter, the resulting solid matter was dried using a vacuum dryer until the water content therein became 0.3% by weight, whereby toner particles were obtained.

After drying, as additives, 2 parts by weight of hydrophobic silica and 0.5 parts by weight of titanium oxide were attached to the surfaces of the toner particles, whereby a desired electrophotographic toner was obtained.

The volume average particle diameter of the thus obtained electrophotographic toner was measured using Multisizer 3 manufactured by Beckman Coulter Inc. and found to be 5.48 μm.

The thus obtained toner was evaluated and good results were obtained with respect to all the test items: filming, charge amount, non-offset temperature range, and storage stability.

The results are shown in the following Table 1.

### Example 4

20 parts by weight of the fine particle dispersion liquid A, 10 parts by weight of the fine particle dispersion liquid H, and 45 parts by weight of ion exchanged water were mixed. Then, as an aggregating agent, 5 parts by weight of a 0.8% by weight aqueous HCl solution was added thereto at 30° C., and the temperature of the resulting mixture was raised to 50° C. Thereafter, 20 parts by weight of a 15% by weight aqueous ammonium chloride solution was added thereto to form a shell layer. In order to control the shape, the temperature of the resulting mixture was raised to 90° C. and the mixture was left as such for 2 hours.

After the obtained dispersion liquid was cooled, the solid matter therein was washed by repeating a procedure including centrifugation of the dispersion liquid using a centrifuge, removal of the resulting supernatant, and washing of the remaining solid matter with ion exchanged water until the electrical conductivity of the supernatant became 50 μS/cm. Thereafter, the resulting solid matter was dried using a vacuum dryer until the water content therein became 0.3% by weight, whereby toner particles were obtained.

After drying, as additives, 2 parts by weight of hydrophobic silica and 0.5 parts by weight of titanium oxide were attached to the surfaces of the toner particles, whereby a desired electrophotographic toner was obtained.

The volume average particle diameter of the thus obtained electrophotographic toner was measured using Multisizer 3 manufactured by Beckman Coulter Inc. and found to be 5.27 μm.

The thus obtained toner was evaluated and good results were obtained with respect to all the test items: filming, charge amount, non-offset temperature range, and storage stability.

The results are shown in the following Table 1.

### Example 5

20 parts by weight of the fine particle dispersion liquid B, 10 parts by weight of the fine particle dispersion liquid D, and 45 parts by weight of ion exchanged water were mixed. Then, as an aggregating agent, 5 parts by weight of a 0.8% by weight aqueous HCl solution was added thereto at 30° C., and the temperature of the resulting mixture was raised to 50° C. Thereafter, 20 parts by weight of a 15% by weight aqueous ammonium chloride solution was added thereto to form a shell layer. In order to control the shape, the temperature of the resulting mixture was raised to 90° C. and the mixture was left as such for 2 hours.

After the obtained dispersion liquid was cooled, the solid matter therein was washed by repeating a procedure including centrifugation of the dispersion liquid using a centrifuge, removal of the resulting supernatant, and washing of the remaining solid matter with ion exchanged water until the electrical conductivity of the supernatant became 50 μS/cm. Thereafter, the resulting solid matter was dried using a vacuum dryer until the water content therein became 0.3% by weight, whereby toner particles were obtained.

After drying, as additives, 2 parts by weight of hydrophobic silica and 0.5 parts by weight of titanium oxide were attached to the surfaces of the toner particles, whereby a desired electrophotographic toner was obtained.

The volume average particle diameter of the thus obtained electrophotographic toner was measured using Multisizer 3 manufactured by Beckman Coulter Inc. and found to be 5.49 μm.

The thus obtained toner was evaluated and good results were obtained with respect to all the test items: filming, charge amount, non-offset temperature range, and storage stability.

The results are shown in the following Table 1.

### Example 6

20 parts by weight of the fine particle dispersion liquid B, 10 parts by weight of the fine particle dispersion liquid F, and 45 parts by weight of ion exchanged water were mixed. Then, as an aggregating agent, 5 parts by weight of a 0.8% by weight aqueous HCl solution was added thereto at 30° C., and the temperature of the resulting mixture was raised to 50° C. Thereafter, 20 parts by weight of a 15% by weight aqueous ammonium chloride solution was added thereto to form a shell layer. In order to control the shape, the temperature of the resulting mixture was raised to 90° C. and the mixture was left as such for 2 hours.

After the obtained dispersion liquid was cooled, the solid matter therein was washed by repeating a procedure including centrifugation of the dispersion liquid using a centrifuge, removal of the resulting supernatant, and washing of the remaining solid matter with ion exchanged water until the electrical conductivity of the supernatant became 50 μS/cm. Thereafter, the resulting solid matter was dried using a vacuum dryer until the water content therein became 0.3% by weight, whereby toner particles were obtained.

After drying, as additives, 2 parts by weight of hydrophobic silica and 0.5 parts by weight of titanium oxide were attached to the surfaces of the toner particles, whereby a desired electrophotographic toner was obtained.

The volume average particle diameter of the thus obtained electrophotographic toner was measured using Multisizer 3 manufactured by Beckman Coulter Inc. and found to be 5.12 μm.

The thus obtained toner was evaluated and good results were obtained with respect to all the test items: filming, charge amount, non-offset temperature range, and storage stability.

The results are shown in the following Table 1.

### Comparative Example 1

25 parts by weight of the fine particle dispersion liquid A and 65 parts by weight of ion exchanged water were mixed. Then, as an aggregating agent, 5 parts by weight of a 0.8% by weight aqueous HCl solution was added thereto at 30° C., and then, in order to control the aggregation and shape, the temperature of the resulting mixture was raised to 90° C. and the mixture was left as such for 2 hours.

After the obtained dispersion liquid was cooled, the solid matter therein was washed by repeating a procedure including centrifugation of the dispersion liquid using a centrifuge, removal of the resulting supernatant, and washing of the remaining solid matter with ion exchanged water until the electrical conductivity of the supernatant became 50 μS/cm. Thereafter, the resulting solid matter was dried using a vacuum dryer until the water content therein became 0.3% by weight, whereby toner particles were obtained.

After drying, as additives, 2 parts by weight of hydrophobic silica and 0.5 parts by weight of titanium oxide were attached to the surfaces of the toner particles, whereby a desired electrophotographic toner was obtained.

The volume average particle diameter of the thus obtained electrophotographic toner was measured using Multisizer 3 manufactured by Beckman Coulter Inc. and found to be 5.34 μm.

The thus obtained toner was evaluated and good results were obtained with respect to non-offset temperature range, however, good results were not obtained with respect to filming, charge amount, and storage stability.

The results are shown in the following Table 1.

### Comparative Example 2

23.8 parts by weight of the fine particle dispersion liquid A, 12.5 parts by weight of the fine particle dispersion liquid D, and 38.7 parts by weight of ion exchanged water were mixed. Then, as an aggregating agent, 5 parts by weight of a 0.8% by weight aqueous HCl solution was added thereto at 30° C., and the temperature of the resulting mixture was raised to 50° C. Thereafter, 20 parts by weight of a 15% by weight aqueous ammonium chloride solution was added thereto to form a shell layer. In order to control the shape, the temperature of the resulting mixture was raised to 90° C. and the mixture was left as such for 2 hours.

After the obtained dispersion liquid was cooled, the solid matter therein was washed by repeating a procedure including centrifugation of the dispersion liquid using a centrifuge, removal of the resulting supernatant, and washing of the remaining solid matter with ion exchanged water until the electrical conductivity of the supernatant became 50 μS/cm. Thereafter, the resulting solid matter was dried using a vacuum dryer until the water content therein became 0.3% by weight, whereby toner particles were obtained.

After drying, as additives, 2 parts by weight of hydrophobic silica and 0.5 parts by weight of titanium oxide were attached to the surfaces of the toner particles, whereby a desired electrophotographic toner was obtained.

The volume average particle diameter of the thus obtained electrophotographic toner was measured using Multisizer 3 manufactured by Beckman Coulter Inc. and found to be 5.66 μm.

The thus obtained toner was evaluated and good results were obtained with respect to non-offset temperature range, however, good results were not obtained with respect to filming, charge amount, and storage stability.

The results are shown in the following Table 1.

### Comparative Example 3

13.8 parts by weight of the fine particle dispersion liquid A, 22.5 parts by weight of the fine particle dispersion liquid D, and 38.7 parts by weight of ion exchanged water were mixed. Then, as an aggregating agent, 5 parts by weight of a 0.8% by weight aqueous HCl solution was added thereto at 30° C., and the temperature of the resulting mixture was raised to 50° C. Thereafter, 20 parts by weight of a 15% by weight aqueous ammonium chloride solution was added thereto to form a shell layer. In order to control the shape, the temperature of the resulting mixture was raised to 90° C. and the mixture was left as such for 2 hours.

After the obtained dispersion liquid was cooled, the solid matter therein was washed by repeating a procedure including centrifugation of the dispersion liquid using a centrifuge, removal of the resulting supernatant, and washing of the remaining solid matter with ion exchanged water until the electrical conductivity of the supernatant became 50 μS/cm. Thereafter, the resulting solid matter was dried using a vacuum dryer until the water content therein became 0.3% by weight, whereby toner particles were obtained.

After drying, as additives, 2 parts by weight of hydrophobic silica and 0.5 parts by weight of titanium oxide were attached to the surfaces of the toner particles, whereby a desired electrophotographic toner was obtained.

The volume average particle diameter of the thus obtained electrophotographic toner was measured using Multisizer 3 manufactured by Beckman Coulter Inc. and found to be 6.15

The thus obtained toner was evaluated and good results were obtained with respect to filming, charge amount, and storage stability, however, good results were not obtained with respect to non-offset temperature range.

The results are shown in the following Table 1.

### Comparative Example 4

20 parts by weight of the fine particle dispersion liquid C, 10 parts by weight of the fine particle dispersion liquid E, and 45 parts by weight of ion exchanged water were mixed. Then, as an aggregating agent, 5 parts by weight of a 0.8% by weight aqueous HCl solution was added thereto at 30° C., and the temperature of the resulting mixture was raised to 50° C. Thereafter, 20 parts by weight of a 15% by weight aqueous ammonium chloride solution was added thereto to form a shell layer. In order to control the shape, the temperature of the resulting mixture was raised to 90° C. and the mixture was left as such for 2 hours.

After the obtained dispersion liquid was cooled, the solid matter therein was washed by repeating a procedure including centrifugation of the dispersion liquid using a centrifuge, removal of the resulting supernatant, and washing of the remaining solid matter with ion exchanged water until the electrical conductivity of the supernatant became 50 μS/cm. Thereafter, the resulting solid matter was dried using a vacuum dryer until the water content therein became 0.3% by weight, whereby toner particles were obtained.

After drying, as additives, 2 parts by weight of hydrophobic silica and 0.5 parts by weight of titanium oxide were attached to the surfaces of the toner particles, whereby a desired electrophotographic toner was obtained.

The volume average particle diameter of the thus obtained electrophotographic toner was measured using Multisizer 3 manufactured by Beckman Coulter Inc. and found to be 5.61 μm.

The thus obtained toner was evaluated and good results were obtained with respect to filming, charge amount, and non-offset temperature range, however, good results were not obtained with respect to storage stability.

The results are shown in the following Table 1.

### Comparative Example 5

20 parts by weight of the fine particle dispersion liquid A, 10 parts by weight of the fine particle dispersion liquid G, and 45 parts by weight of ion exchanged water were mixed. Then, as an aggregating agent, 5 parts by weight of a 0.8% by weight aqueous HCl solution was added thereto at 30° C., and the temperature of the resulting mixture was raised to 50° C. Thereafter, 20 parts by weight of a 15% by weight aqueous ammonium chloride solution was added thereto to form a shell layer. In order to control the shape, the temperature of the resulting mixture was raised to 90° C. and the mixture was left as such for 2 hours.

After the obtained dispersion liquid was cooled, the solid matter therein was washed by repeating a procedure including centrifugation of the dispersion liquid using a centrifuge, removal of the resulting supernatant, and washing of the remaining solid matter with ion exchanged water until the electrical conductivity of the supernatant became 50 μS/cm. Thereafter, the resulting solid matter was dried using a vacuum dryer until the water content therein became 0.3% by weight, whereby toner particles were obtained.

After drying, as additives, 2 parts by weight of hydrophobic silica and 0.5 parts by weight of titanium oxide were attached to the surfaces of the toner particles, whereby a desired electrophotographic toner was obtained.

The volume average particle diameter of the thus obtained electrophotographic toner was measured using Multisizer 3 manufactured by Beckman Coulter Inc. and found to be 5.76 μm.

The thus obtained toner was evaluated and good results were obtained with respect to non-offset temperature range, however, good results were not obtained with respect to filming, charge amount, and storage stability.

The results are shown in the following Table 1.

### Comparative Example 6

20 parts by weight of the fine particle dispersion liquid A, 10 parts by weight of the fine particle dispersion liquid I, and 45 parts by weight of ion exchanged water were mixed. Then, as an aggregating agent, 5 parts by weight of a 0.8% by weight aqueous HCl solution was added thereto at 30° C., and the temperature of the resulting mixture was raised to 50° C. Thereafter, 30 parts by weight of a 15% by weight aqueous ammonium chloride solution was added thereto, however, a shell layer could not be formed.

The results are shown in the following Table 1.

TABLE 1

| | | | Solid | | | Absolute | | | | | |
|---|---|---|---|---|---|---|---|---|---|---|---|
| | | | content | | | value of | | | | | |
| | | | weight | | | difference in | | | | | |
| | | | ratio of | Zeta | Zeta | zeta potential | | | | | |
| | | | dispersion | potential of | potential of | between | | | | | |
| | Fine | Fine | liquid | fine particle | fine particle | dispersion | Toner | | | | |
| | particle | particle | (1) to | dispersion | dispersion | liquid (1) | particle | | | Non-offset | |
| | dispersion | dispersion | dispersion | liquid (1) | liquid (2) | and dispersion | diameter | | Charge | temperature | Storage |
| | liquid (1) | liquid (2) | liquid (2) | (mV) | (mV) | liquid (2) (mV) | (μm) | Filming | amount | range | stability |
| Example 1 | A | D | 8/2 | −27.64 | −35.87 | 8.23 | 5.81 | A | A | A | A |
| Example 2 | A | D | 6/4 | −27.64 | −35.87 | 8.23 | 6.32 | A | A | A | A |
| Example 3 | A | D | 9/1 | −27.64 | −35.87 | 8.23 | 5.48 | A | A | A | A |
| Example 4 | A | H | 8/2 | −27.64 | −42.32 | 14.68 | 5.27 | A | A | A | A |
| Example 5 | B | D | 8/2 | −29.27 | −35.87 | 6.60 | 5.49 | A | A | A | A |
| Example 6 | A | F | 8/2 | −27.64 | −32.96 | 5.32 | 5.12 | A | A | A | A |
| Comparative | A | — | — | −27.64 | — | — | 5.34 | C | C | A | C |
| example 1 | | | | | | | | | | | |
| Comparative | A | D | 9.5/0.5 | −27.64 | −35.87 | 8.23 | 5.66 | C | C | A | B |
| example 2 | | | | | | | | | | | |
| Comparative | A | D | 5.5/4.5 | −27.64 | −35.87 | 8.23 | 6.15 | A | A | C | A |
| example 3 | | | | | | | | | | | |
| Comparative | C | E | 8/2 | −29.31 | −36.17 | 6.86 | 5.61 | A | A | A | C |
| example 4 | | | | | | | | | | | |
| Comparative | A | G | 8/2 | −27.64 | −30.82 | 3.18 | 5.76 | C | C | A | B |
| example 5 | | | | | | | | | | | |

| | | | | | | | |
|---|---|---|---|---|---|---|---|
| Comparative | A | I | 8/2 | −27.64 | −43.16 | 15.52 | Encapsulation could not be achieved. |
| example 6 | | | | | | | |

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method for producing a developing agent comprising:
forming a mixed dispersion liquid by mixing a first dispersion liquid containing first fine particles containing a first binder resin and a coloring agent with a second dispersion liquid containing second fine particles containing at least either one of the first binder resin and a second binder resin which is different from the first binder resin;
forming core particles by adding an aggregating agent to the mixed dispersion liquid to selectively aggregate the first fine particles; and
forming shells on the surfaces of the core particles by adding a pH adjusting agent to the mixed dispersion liquid containing the core particles to aggregate the second fine particles thereon; wherein
the absolute value of the difference between the zeta potential of the first dispersion liquid (Z1) and the zeta potential of the second dispersion liquid (Z2) measured when the concentration of solid content in each of the first dispersion liquid and the second dispersion liquid is set to 5% by weight, and 5% by weight of aluminum sulfate is added to each dispersion liquid in an amount of 1% by weight based on the solid content in each dispersion liquid, followed by diluting the dispersion liquids to 5 ppm satisfies the relationship represented by the following formula (1):
15 mV≧|Z2−Z1|≧5 mV (1).

2. The method according to claim 1, wherein the solid content weight ratio of the first dispersion liquid to the second dispersion liquid (first dispersion liquid/second dispersion liquid) is from 6/4 to 9/1.

3. The method according to claim 1, wherein the first dispersion liquid and the second dispersion liquid each further contain a surfactant, and the weight of the surfactant in the second dispersion liquid is more than that of the surfactant in the first dispersion liquid.

4. The method according to claim 1, wherein the first fine particles have a volume average particle diameter of from 0.3 to 1.0 μm.

5. The method according to claim 1, wherein the developing agent has a volume average particle diameter of from 3 to 10 μm.

6. The method according to claim 1, wherein the second dispersion liquid contains the second binder resin and the second binder resin has a glass transition temperature (Tg) which is higher than that of the first binder resin.

7. A developing agent comprising:
core particles formed by using first fine particles containing a first binder resin and a coloring agent; and
shells formed on the surfaces of the core particles by using second fine particles containing at least either one of the first binder resin and a second binder resin which is different from the first binder resin; wherein
the developing agent is produced by mixing a first dispersion liquid containing the first fine particles with a second dispersion liquid containing the second fine particles to form a mixed dispersion liquid, and adding an aggregating agent to the mixed dispersion liquid to selectively aggregate the first fine particles thereby forming core particles, and then, adding a pH adjusting agent to the mixed dispersion liquid containing the core particles to aggregate the second fine particles on the surfaces of the core particles thereby forming shells; and
the absolute value of the difference between the zeta potential of the first dispersion liquid (Z1) and the zeta potential of the second dispersion liquid (Z2) measured when the concentration of solid content in each of the first dispersion liquid and the second dispersion liquid is set to 5% by weight, and aluminum sulfate is added to each dispersion liquid in an amount of 1% by weight based on the solid content in each dispersion liquid satisfies the relationship represented by the following formula (1):
15 mV≧|Z2−Z1|≧5 mV (1).

8. The developing agent according to claim 7, wherein the solid content weight ratio of the first dispersion liquid to the second dispersion liquid (first dispersion liquid/second dispersion liquid) is from 6/4 to 9/1.

9. The developing agent according to claim 7, wherein the first dispersion liquid and the second dispersion liquid each further contain a surfactant, and the weight of the surfactant in the second dispersion liquid is more than that of the surfactant in the first dispersion liquid.

10. The developing agent according to claim 7, wherein the first fine particles have a volume average particle diameter of from 0.3 to 1.0 μm.

11. The developing agent according to claim 7, wherein the developing agent has a volume average particle diameter of from 3 to 10 μm.

12. The developing agent according to claim 7, wherein the second dispersion liquid contains the second binder resin and the second binder resin has a glass transition temperature (Tg) which is higher than that of the first binder resin.
